(19) United States
(12) Patent Application Publication
(10) Pub. No.: US 2004/0127590 A1
(43) Pub. Date: Jul. 1, 2004

(54) Formulation for a rigid polyurethane foam having improved impact resistance

(76) Inventors: Leroy Whinnery JR., Danville, CA (US); Steven H. Goods, Livermore, CA (US); Dawn M. Skala, Fremont, CA (US); Craig C. Henderson, Livermore, CA (US)

Correspondence Address: Timothy Evans, MS 9031, Sandia National Laboratories, 7011 East Avenue, Livermore, CA, 94550, US

(21) Appl. No.: 10/328,316

(22) Filed: Dec. 20, 2002

(51) Int. Cl. C08J 9/00; C08G 18/00

(52) U.S. Cl. 521/159

(57) ABSTRACT

Disclosed is a polyurethane closed-cell foam composition exhibiting an ability to absorb very high strain rate compression without loss of structural integrity by brittle fracture, spalling, or splintering. The new composition further exhibits no loss or degradation in conventional mechanical properties, particularly its response to low rate compression. The new formulation of the present embodiemnt is based on the reaction product of a modified MDI isocyanate and a sucrose/glycerine based polyether polyol resin catalyzed by a mixture of one or more tertiary amines and water wherein the isocyanate and polyol resin each have a low number of functional groups per monomer and a high number of rotational degrees of freedom.

### STATEMENT OF GOVERNMENT INTEREST

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing in this invention to license others on reasonable terms.

### BACKGROUND OF THE INVENTION

1. Field of the Invention

The invention generally relates to a rigid polyurethane foam composition exhibiting improved high strain-rate compression response (impact resistance) with little or no degradation in conventional mechanical properties. More particularly, the embodiment of the present invention relates to closed-cell, water blown, rigid polyurethane foams which may be processed with bulk densities having a relatively wide range that do not fail catastrophically when loaded at very high strain-rates and are, therefore, useful in energy management systems or in those applications where energy absorption is important.

2. Prior Art

In many applications, polyurethane foams are used to absorb, or at least mitigate, the effects of high acceleration loads. In particular, low density polyurethane foams are widely used as a packing media while rigid, high density polyurethane foams are used in the construction of automobile bumpers and to stiffen door support frames. Additionally, many polyurethane foams currently using TDI (toluene diisocyanate) and MDI (diphenylmethane diisocyanate) prepolymers have not been intentionally optimized with respect to their toughness or impact properties. As such, there has been a growing need to develop polyurethane foam systems with improved energy absorbing capacity.

For example, U.S. Pat. No. 4,722,946 describes the production of energy attenuating viscoelastic polyurethane elastomers and foams, comprising mixtures of linear and branched polyol intermediates, polyisocyanates in the presence of a catalyst. Additionally, U.S. Pat. No. 4,696,954 describes the preparation of molded polyurethane foams characterized by high impact strength and good thermal stability. Furthermore, some limited success has been had with certain formulations using water as a blowing agent, and containing a polymer polyol (graft polyol) as necessary elements of the invention. U.S. Pat. Nos. 4,190,712, 4,212,954, and 4,116,893 disclose formulations for flexible or viscoelastic foams.

While many energy absorbing polyurethane foam compositions are known in the art, there appears to be a need for foam compositions that are simple and utilize commercially available materials.

### SUMMARY OF THE INVENTION

The present embodiment relates to impact resistant polyurethane foam compositions, the process for preparing these foams, and the articles made with these formulations.

More particularly, the polyurethane foam of the present embodiment comprises the reaction product of a modified MDI isocyanate and a sucrose/glycerine based polyether polyol resin catalyzed by a mixture of one or more tertiary amines and water wherein the isocyanate and polyol resin each have a low number of functional groups per monomer and a high number of rotational degrees of freedom.

Still further, the resulting foams can be processed over a fairly broad range of densities without affecting the desired properties afforded by the foam formulations of the present embodiment.

Yet another object of the present embodiment is to provide a polyurethane composition and foam member therefrom capable of sustaining an impact load to a true strain of about 1 at a strain rate of up to 80 inches/inch-sec without structural failure and corresponding loss of energy absorbing capacity.

A further object of this embodiment is to provide a polyurethane composition and foam member therefrom capable of providing a low rate strain behavior essentially identical to a foam member provided by polyurethane composition whose constituent materials have not been chosen on the basis of functional group number or rotational degrees of freedom.

Still other objects and advantages of the present embodiment will be ascertained from a reading of the following detailed description and the appended claims.

### BRIEF DESCRIPTION OF THE DRAWINGS

FIGS. 1A and 1B illustrate the mechanical behavior of a conventional polyurethane foam and a foam of an embodiment of the present invention, at both high and low strain rates.

FIG. 2 provides a comprehensive visual representation of the ability of each of the 20 polyurethane formulations to withstand high strain-rate compression loading.

FIG. 3 illustrates the low strain rate mechanical performance of the x003 series of polyurethane formulations.

FIG. 4 illustrates the low strain rate mechanical performance of the 400x series of polyurethane formulations.

FIG. 5 illustrates the high and low strain rate mechanical behavior the 1003 of polyurethane formulations.

FIG. 6 illustrates the high and low strain rate mechanical behavior the 4001 of polyurethane formulations.

### DETAILED DESCRIPTION OF THE INVENTION

The polyurethane formulation of the present embodiment of the invention was determined from a design experiment comprising an n×m matrix of two active constituent materials. In particular, it was postulated that a polyurethane foam exhibiting enhanced toughness could be obtained by formulating a polymer comprising constituent materials having a low number of functional groups per monomer (fcn) and high rotational degrees of freedom (Nᵣₒₜ). To test this hypothesis, foam test samples comprising each of 4 different isocyanate prepolymers and 5 different polyol resins were prepared and subjected to a variety of mechanical compression tests, including quasi-static and high strain rate loading.

The second factor is designated as an Impact Index, or Iᵢₙ, and is calculated for each sample based on published information regarding the chemical structure of the polymer/monomer molecule in question. In particular, Iᵢₙ, requires information regarding the number of functional, or side groups, associated with the polymer/monomer and the rotational degrees of freedom of these components alone as well as those associated with a polymer backbone, i.e.,

$${I}_{in} = ( \frac{{N}_{rot \text{-} polyol}}{{fcn}_{polyol}} ) + ( \frac{{N}_{rot \text{-} NCO}}{{fcn}_{NCO}} ) \qquad Eq . ( 1 )$$

where fcn is the number of functional groups per monomer of the polyol and the isocyanate, respectively and where Nᵣₒₜ is defined as, the number of freely rotating single bonds between nearest functional groups of a monomer for both the polyol (N_{rot-polyol}) and the isocyanate (N_{rot-NCO}). The values of Iᵢₙ, and the supporting data for these values is shown in TABLE 1a - TABLE 1c below for each of the 20 polyurethane formulations prepared herein.

TABLE 1a

| | N_{rot-polyol} | fcn_{polyol} | Nᵣₒₜ/fcn |
|---|---|---|---|
| V490 | 9 | 4.3 | 2.1 |
| V335 | 15 | 3.8 | 3.9 |
| V225 | 9 | 3 | 3.0 |
| V270 | 21 | 3 | 7.0 |
| V280 | 15 | 7 | 2.1 |

Values of Nᵣₒₜ and fcn for the polyols used herein

TABLE 1b

| | N_{rot-NCO} | fcn_{NCO} | Nᵣₒₜ/fcn |
|---|---|---|---|
| 143L | S | 2.1 | 2.4 |
| 94 | 4 | 2.3 | 1.7 |
| 181 | 8.5 | 2 | 4.3 |
| 580N | 4 | 3 | 1.3 |

Values of Nᵣₒₜ and fcn for the isocyanates used

TABLE 1c

ISOCYANATE

| Iᵢₙ | 143L | 94 | 181 | 580N |
|---|---|---|---|---|
| POLYOLS | | | | |
| V490 | 4.5 | 3.8 | 6.4 | 3.4 |
| V335 | 6.3 | 5.7 | 8.2 | 5.2 |
| V225 | 5.4 | 4.7 | 7.3 | 4.3 |
| V270 | 9.4 | 8.7 | 11.3 | 8.3 |
| V280 | 4.5 | 3.8 | 6.3 | 3.4 |

Computed Impact Index (Iᵢₙ) based on the sum of Nᵣₒₜ| fcn values listed in Tables

It is a known to use a glycerin/sucrose initiated polyether polyol resin (the “polyol resin”) as one route to preparing a polyurethane foam. The preferred group of polyol resins, chosen for use in the present embodiment, exhibit a low number of functional groups and a high N_{rot-polyol} number. All are manufactured by the Dow Chemical Company under the tradename VORANOL®. The specific materials chosen were VORANOL® V490, V335, V225, V270, and V280 and while other materials having the same general chemical makeup may be possible, their suitability has not been investigated.

The isocyanate component used herein is a mixture of compounds comprising 4,4′-diphenylmethane diisocyanate and 2,4-diphenylmethane diisocyanate together with a smaller fraction of a polyether polyol prepolymer. Again the preferred group of materials exhibit a low number of functional groups and a high N_{rot-NCO} number. Suitable materials are manufactured by the Dow Chemical Company and are identified by the trade names ISONATE® and PAPI®. The selected isocyanate prepolymers and included ISONATE® 143L and 181, and PAPI® 94 and 580N.

A 4×5 design matrix of the above materials is shown below in TABLE 2. Polyurethane test specimen were prepared using each of the five polyol resins and identified as sample series 100x through 500x, where x runs from 1 through 4 to indicate each of the isocyanate components. Each sample combination was prepared by first mixing one of the five polyol resins with several minor components comprising 1) a “blowing” agent to react with the isocyanate component in order to produce CO₂ such as a small quantity of distilled water; 2) an amine catalyst to promote the reaction between the polyether polyol and the isocyanate, particularly a tertiary amine; and 3) an optional surface active agent, or “surfactant,” such as any of a number of polysiloxane compounds. Other suitable “blowing agents are any of a number of organic solvents such as pentane, iso-pentane, low molecular weight fluoroalkanes, (e.g. fluorinerts), CFC's and HCFC's. Mixing was done by hand.

TABLE 2
ISOCYANATE

| Constituent | | | | 143L | 94 | 181 | 580N |
|---|---|---|---|---|---|---|---|
| | Avg MW | | | 303 | 290 | 364 | 375 |
| | | Fcn | | 2.1 | 2.3 | 2.0 | 3.0 |
| | | | Equi. Wt | 145 | 131 | 182 | 138 |
| POLYOL | | | | | | | |
| V490 | 460 | 4.3 | 107 | 1001 | 1002 | 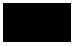 | 1004 |
| V225 | 640 | 3.8 | 168 | 2001 | 2002 | 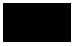 | 2004 |
| V335 | 250 | 3.0 | 83 | 3001 | 3002 | 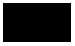 | 3004 |
| V270 | 700 | 3.0 | 233 | 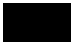 | 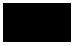 | 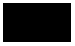 | 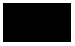 |
| V280 | 1382 | 7.0 | 197 | 5001 | 5002 | 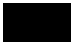 | 5004 |

After mixing the polyol resin and the minor components, one of the four isocyanate components is added and the entire batch is mechanically mixed for about 1 minute.

Suitable catalysts, or mixtures of catalysts, for catalyzing the reaction between the polyol resin and the isocyanate, include tertiary amines such as triethylenediamine, and trimethyl N′, 2-hydroxyethyl-propylenediamine. The formulations of the present embodiment used a triethylenediamine sold by Air Products Inc., under the tradename DABCO 33-LV® as the preferred catalyst.

Numerous suitable surfactants are available and have been found to be satisfactory. Of these, the nonionic surface-active agents such as the well-known silicones have been found to be particularly effective. The optional surfactant used in the present embodiment of the invention is a silicone surfactant manufactured by Air Products Inc., under the tradename DC193®.

In order to prepare each of the test samples, a batch weight of about 250 grams of the polyurethane formulation was mixed and about 200 grams of the liquid immediately dispensed into a cylindrical mold measuring about 5.5″ in diameter by about 3″ in height. The mold was then capped and the foam was allowed to expand in a constrained manner with only a few small vent holes to allow excess gas to escape. After foam expansion the mold was heated to about 66° C.±5° C. for about 12 to 16 hours in order to cure the molded polyurethane foam.

After curing, the molded part is cooled to room temperature and de-molded. Mechanical test samples were then prepared from each of these molded cylindrical samples by first removing about ⅜″ from one of the two cylinder faces and then perpendicularly “coring” into the freshly cut cylinder face to a depth of about 2.25″. Eight such test samples, measuring about 1.13″ in diameter, were cut from each of the large cast foam cylinders. After coring the test samples, the uncut face of the cast foam cylinder was removed in the same manner as the first face to release the eight core sections. These samples were then completed by sanding the faces flat and parallel such that each of the finished test samples had an overall height of about 2″.

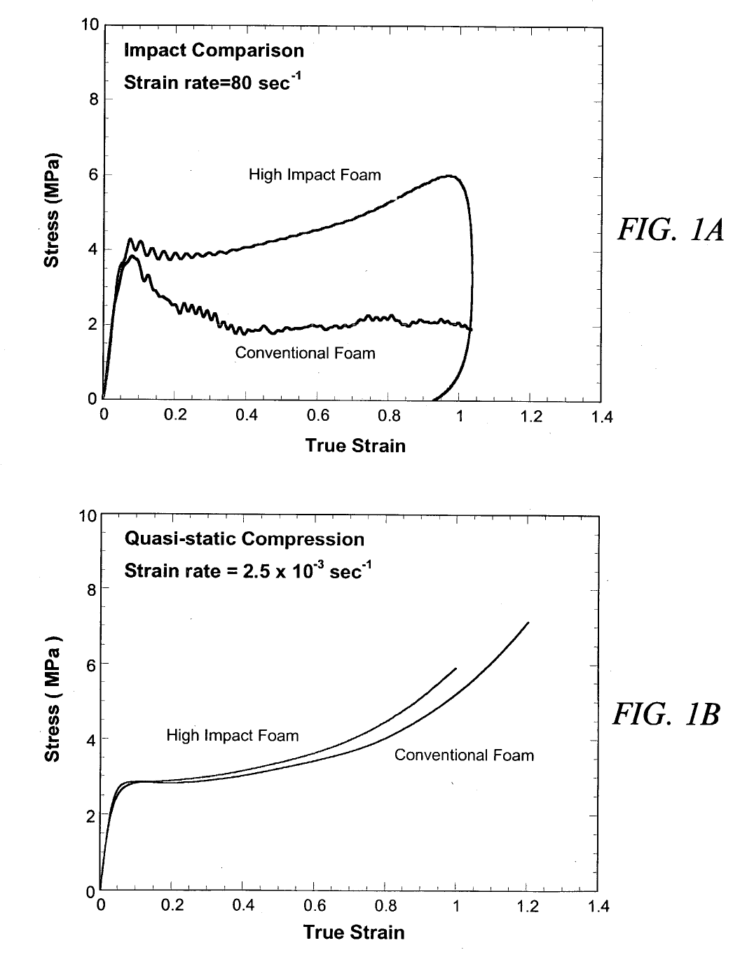

Each of the of the twenty combinations of isocyanate and polyol resin therefore was prepared as above to provide multiple test samples. Each specimen was then subjected either to low rate mechanical compression loading at a strain rate of about 0.0025 inches/inch-sec., or to high rate compression loading of about 80 inches/inch-sec. The purpose of this testing was to provide a basis for comparing the impact sensitivity of each of the 20 formulations as well as a basis for comparison of the low rate or quasi-static mechanical behavior of these formulations against the known mechanical behavior of conventional polyurethane foams. In particular, FIGS. 1A and 1B illustrate the mechanical behavior, at both high and low strain rates, of a polyurethane foam produced with a conventional formulation as compared to one produced with a foam of the present embodiment. Test specimen fabricated with this foam show the characteristic quasi-static low rate behavior but fail abruptly at a true strain of about 0.1, when subjected to high strain rate.

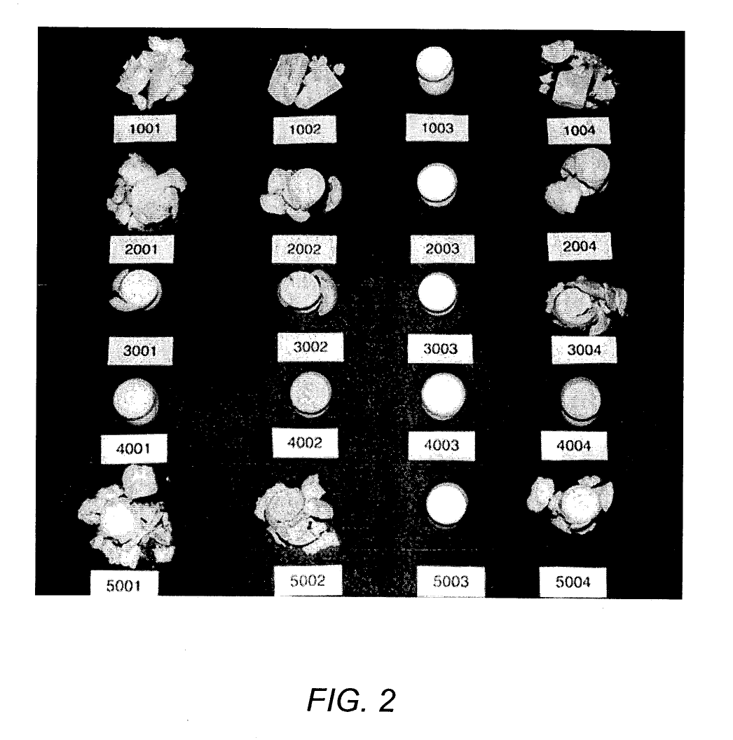

Representative polyurethane foam specimens of each of the 20 resin formulations, therefore, were prepared and tested under conditions of both high and low rate mechanical compression. In order to provide a comprehensive visual representation of the ability of the polyurethane formulations to withstand high-rate compression loading, a photograph was taken of the residue of representative samples of each formulation group tested. FIG. 2 shows this representation. As is readily seen, foam specimen prepared with either the VORANOL® 270 resin (the 400x series), or the ISONATE® 181 prepolymer (the x003 series) did not exhibit catastrophic failure.

However, what is desired is a formulation that not only provides good high rate impact resistance but also good low rate compression behavior as well. In order to help quantify the high rate mechanical test results, and to help predict which general formulations would provide consistent high rate performance, a second summary factor was developed defined as the volumetric energy (Γᵢₙ) absorbed by the test sample. The quantity Γᵢₙ is experimentally derived by integrating the area under the measured stress-strain curve for each sample tested under high-rate loading and therefore relates to the ability of the test sample to resist impact loading.

TABLE 3 shows the measured Γᵢₙ value for each of the twenty polyurethane formulations tested herein.

By comparing the results tabulated in TABLE 3 with the visual characteristics shown in FIG. 2 it is apparent that all the test samples exhibiting a volumetric energy absorption, Γᵢₙ, of about 3 or below fail catastrophically (Γᵢₙ numbers in the present application cannot exceed 3.5 because the travel of the compression apparatus cross head is terminated at about a true strain of 1 for each sample). Moreover, it was found experimentally, based on low rate mechanical testing, that as the impact index, Iᵢₙ, increased, the low rate, or quasi-static, mechanical properties of the foam decreased principally manifested as a decrease in strength compression. It was found that foam formulations that provided an Iᵢₙ above about 9 did not provide the desired low (strain) rate mechanical behavior.

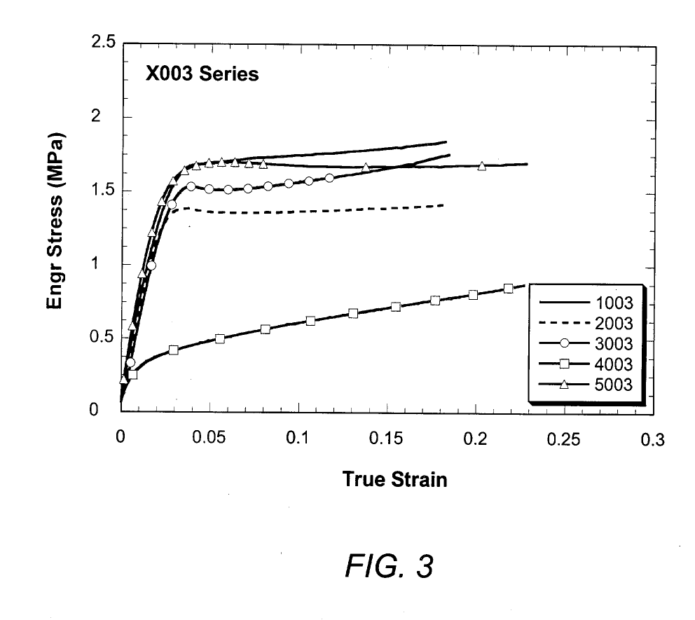

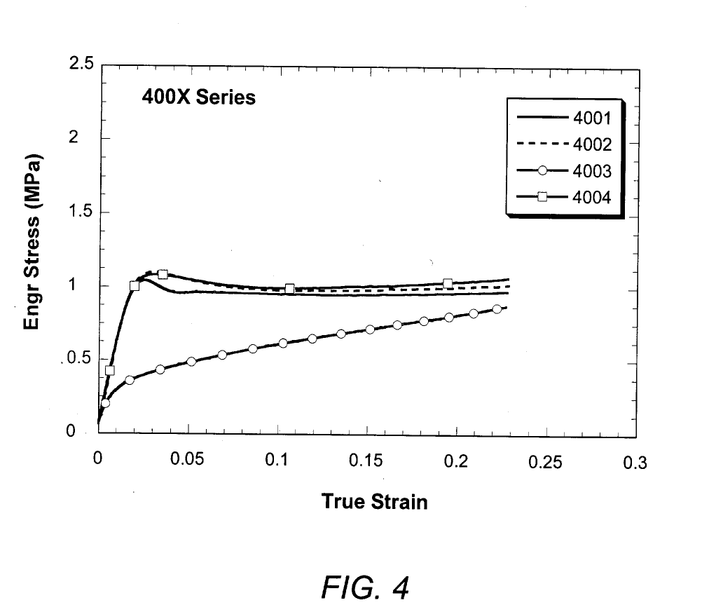

Of the above test specimens, therefore, those identified as 1003, 3003, and 5003, prepared with the 181 MDI isocyanate, and 4001, 4002, and 4004 prepared with the 143L, 94 and 580N MDI isocyanate, respectively, provided the best high rate compression resistance. However, as shown in FIGS. 3 and 4 which illustrate the low strain rate mechanical performance of the 0003 and the 4000 series of formulation, respectively, those combinations comprising the 4000 series of test specimen made with the VORANOL® 270 polyol resin provided only about 60% of the conventional low-strain rate performance of the 1003, 3003, and 5003 formulations with regard to compressive strength or energy absorption. Of these, the best low rate performance was provided by the 1003, 3003 and 5003 formulations in that these formulations showed no loss of conventional mechanical strength.

TABLE 3

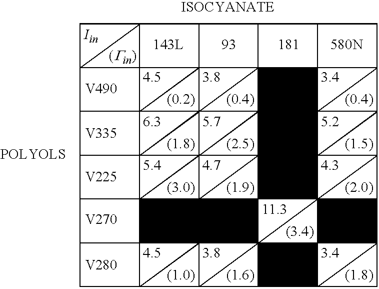

Of the two identified isocyanate/polyol combinations, the combination of the VORANOL® 490 polyol and the ISONATE® 181 MDI isocyanate (the 1003 combination), provided the best low and high strain rate performance, and is, therefore, the preferred combination. Other combinations, of course, particularly 2003, 3003, and 5003, provided an acceptable overall performance although the low rate compression behavior of 2003, and 3003 is marginally degraded.

The following examples are provided as a way to better describe the present embodiment. Each includes the formulation used to prepare the polyurethane foam body. Each of the test samples tested was prepared so as to have a nominal density of about 0.16±0.01 grams/cm³. While these samples were prepared using a nominal density of 0.16 grams/cm³, the present embodiment is not restricted to this density alone. Other densities over a range of densities from 0.07 grams/cm³ to about 0.55 grams/cm³ have been prepared and tested. The nominal density was selected for convenience only in order to provide a baseline for comparison.

### EXAMPLE 1

### Formulation 1003

The formulation for providing polyurethane 1003 is shown below.

| | | |
|---|---|---|
| Voranol ® 490 | 85.7 g | 34.2% |
| DC 193 ® | 2.0 g | 0.80% |
| 33-LV ® | 0.4 g | 0.16% |
| Water | 0.8 g | 0.32% |
| Isonate ® 181 | 161.5 g | 64.5% |

The VORANOL® 490 polyol resin, is first mixed together with the amine catalyst (33-LV®), the silicone surfactant (DC 193®), and distilled water in a wide mouth pail, or mixing bowl using a broad blade spatula. Mixing is performed for about 1 minute until each of the minor constituents is folded into the polyol resin. The MDI ISONATE® 181 is then added to the mixed resin and again mixed for about 1 minute using a low-shear, 2 inch impeller, known as a ConnBlade® (manufactured by Conn & Company), turning at 1500 rpm.

In order to prepare each of the test samples a batch weight of about 250 grams of the polyurethane foam was mixed. Once mixed, the resin is immediately dispensed into a cylindrical mold, measuring about 13.9 cm (5.47″) in diameter by about 7.6 cm (3″) in height, and filling the mold with about 184 grams of liquid, capped and allowed to rise in a constrained state. The molded polyurethane foam is then heated to about 66° C.±5° C. for about 12 to 16 hours in order to cure the polymer, after which it is cooled to room temperature and de-molded.

Approximately 8 mechanical test specimens were prepared from each of the molded foam samples. In order to provide these samples the large 5.47″ diameter cast foam cylinder was first cut across one of its faces to remove about the first ⅜″ of the cylinder length. A 1.13″ inside diameter core drill was then used to cut 8 more or less identical core samples into the newly cut cylinder face. Each core was taken to a depth of about 2.25″ after which point another ⅜″ was removed from the remaining uncut cylinder face to yield the eight test sample cylinders. In order to complete the preparation of the test samples, the faces of the cylinders were sanded flat and parallel to a final height of 2″.

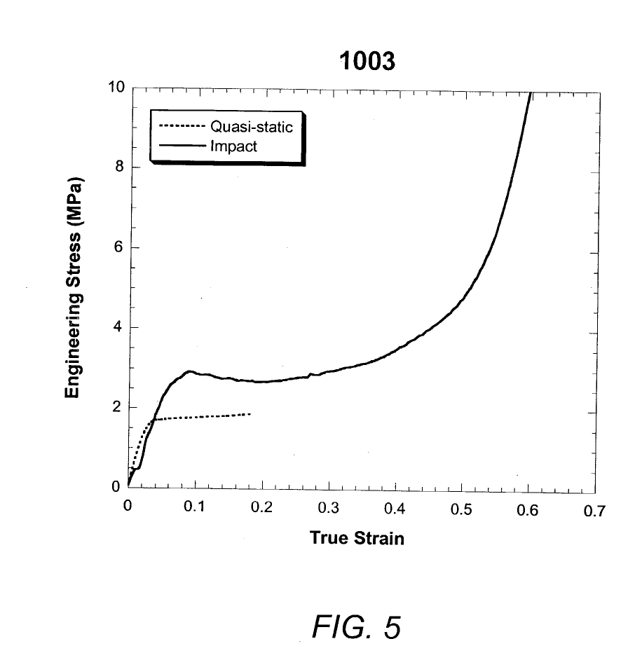

Test samples thus prepared were subjected to identical environment of mechanical loading. In particular, test samples prepared with each formulation were subjected to high-rate mechanical compression at a strain rate of about 80 inches/inch-sec and to quasi-static (low rate) compression at a strain rate of about 0.0025 inches/inch-sec. FIG. 5 shows representative stress-strain curves for this material.

### EXAMPLE 2

### Formulation 3003

The formulation for providing polyurethane 4001 is shown below.

| | | |
|---|---|---|
| Voranol ® 280 | 112.7 g | 45.1% |
| DC 193 ® | 2.67 g | 1.07% |
| 33-LV ® | 0.4 g | 0.16% |
| Water | 1.1 g | 0.42% |
| Isonate ® 181 | 133.1 g | 53.3% |

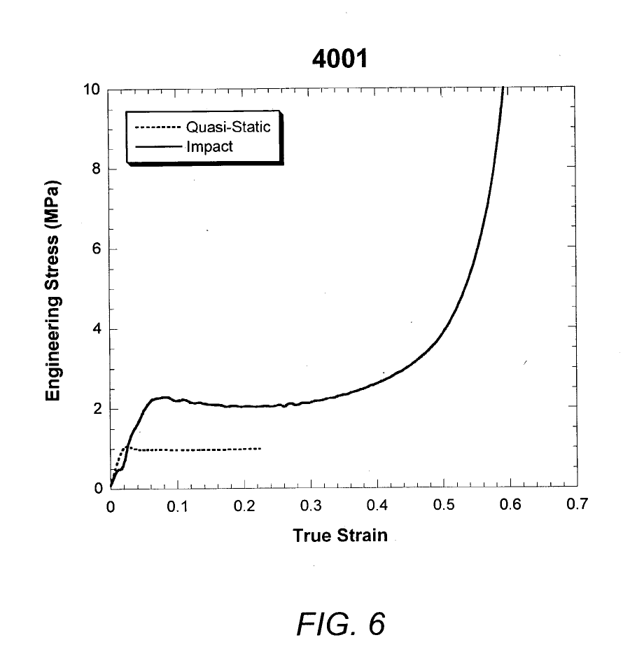

The 4001 formulation was prepared as described above in Example 1 as was the associated test samples. These test samples were then subjected to the same test regime of mechanical loading as that to which the 1003 test samples had been subjected. In particular, test samples were subjected to high-rate mechanical compression at a strain rate of about 80 inches/inch-sec and to quasi-static (low rate) compression at a strain rate of about 0.0025 inches/inch-sec. FIG. 6 shows representative stress-strain curves for this material.

Finally, because it is believed that the operative factors for providing a polyurethane foam that is both resistant to high strain rates without loss of conventional mechanical performance are dependent upon constituent materials having a low number of functional groups per monomer (fen) and high rotational degrees of freedom (Nᵣₒₜ), other polyol/isocyanate combinations using other commercially available products are possible for providing impact resistant polyurethane foams. The specific, recited materials, therefore, are intended to be illustrative only and not limiting. Other formulations exhibiting an Impact Index, Iᵢₙ, between about 6 and 9 should also exhibit the desired properties of high and low rate strain behavior.

Therefore, while the particular formulations as described herein, are fully capable of attaining the objects of this embodiment, it is to be understood that they are the presently preferred embodiments of the present invention and are thus representative of the subject matter which is broadly contemplated by the present invention, that the scope of the present invention is intended to encompass those other embodiments which may become obvious to those skilled in the art, and that the scope of the present invention is accordingly to be limited by nothing other than the appended claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”. All material quantities and amounts are in parts by weight, or by weight percentages, unless otherwise indicated.

What is claimed is:

1. A resin composition for preparing a rigid, impact resistant polyurethane foam structure, comprising:
a) an isocyanate-reactive component comprising a mixture of diphenylmethane diisocyanate, methylene bisphyenyl isocyanate and a polyurethane prepolymer, said mixture having an isocyanate content of about 23% by weight and a functionality number of about 2.
b) a sucrose/glycerine initiated polyether polyol having a functionality number of about 4;
c) a blowing agent reactive with said isocyanate-reactive component, said blowing agent present in amounts sufficient to cause formation of a closed-celled foam, without causing collapse of said foam;
d) an amine catalyst; and
e) a surface active agent;

2. The resin composition of claim 1, wherein the blowing agent is present in amounts of about 0.02 weight percent to about 1.0 weight percent.

3. The resin composition of claim 1, wherein said polyether polyol has an average functionality of 4.3.

4. The resin composition of claim 1, wherein said amine catalyst is a mixture of a tertiary amine and a solvent.

5. The resin composition of claim 4, wherein said mixture comprises triethylenediamine and dipropylene glycol.

6. The resin composition of claim 1, wherein the blowing agent is water or an organic solvent.

7. The resin composition of claim 6, wherein the organic solvent is selected from the group consisting of pentane, iso-pentane, low molecular weight fluoroalkanes, CFCs and HCFCs.

8. A resin composition for preparing a rigid, impact resistant polyurethane foam structure, comprising:
a) an isocyanate-reactive component comprising a mixture of diphenylmethane diisocyanate, methylene bisphyenyl isocyanate and a polyurethane prepolymer, said mixture having an isocyanate content of about 23% by weight and a functionality number of about 2.
b) a sucrose/glycerine initiated polyether polyol having a functionality number of about 4;
c) a blowing agent consisting essentially of water, the water present in amounts sufficient to cause formation of a closed-celled foam, without causing collapse of said foam;
d) an amine catalyst; and
e) a surface active agent;

9. The resin composition of claim 8, wherein water is present in amounts of about 0.02 weight percent to about 1.0 weight percent.

10. The resin composition of claim 8, wherein said polyether polyol has an average functionality of 4.3.

11. The resin composition of claim 8, wherein said amine catalyst is a mixture of a tertiary amine and a solvent.

12. The resin composition of claim 11, wherein said mixture comprises triethylenediamine and dipropylene glycol.

13. An impact resistant closed cell polyurethane foam made by the process, comprising the steps of:
combining a sucrose/glycerine initiated polyether polyol having a functionality number of about 4, with a blowing agent consisting essentially of water, and an tertiary amine catalyst; to provide a mixed resin mixture;
combining said mixed resin mixture with an isocyanate-reactive component, comprising a mixture of diphenylmethane diisocyanate and a polyurethane prepolymer, wherein said mixture has an isocyanate content of about 23% by weight and a functionality number of about 2 to provide a combined polymer mixture;
mechanically mixing said combined polymer mixture for about 1 minute to provide a pre-expanded foam gel;
dispensing said gel into a mold and allowing said gel to react and expand into a closed cell polyurethane foam; and
heating said mold and said expanded polyurethane foam to about 65° C. for about 12 hours to about 16 hours to provide a cured foam member, wherein said foam member is capable of withstanding a true strain of at least 1 under a strain rate of at least 80 in/in second without fracture.

14. The process of claim 13, wherein said first step of combining further includes a surface active agent.

15. A rigid impact-resistant foam member, comprising:
a dense, closed cell structure comprising a cross-linked polyurethane foam, wherein said polyurethane foam is formed by a reaction between an isocyanate-reactive component having a low functionality number per monomer, a sucrose/glycerine initiated polyether polyol resin having a low functionality number and a high number of rotational degrees of freedom per molecule, a tertiary amine catalyst, and water, to provide a foam member able to withstand a true strain of at least 1 at a strain rate of at least 80 in/in second without fracturing.
